(19) United States
(12) Patent Application Publication
(10) Pub. No.: US 2002/0076151 A1
(43) Pub. Date: Jun. 20, 2002

(54) Optical collimator device utilizing an integrated lens/spacer element

(76) Inventors: William Brian Kinard, Redwood City, CA (US); David Michael Rowe, Medway, CA (US)

Correspondence Address: SAWYER LAW GROUP LLP, P.O. Box 51418, Palo Alto, CA, 94303, US

(21) Appl. No.: 09/739,951

(22) Filed: Dec. 18, 2000

(51) Int. Cl. G02B 6/32

(52) U.S. Cl. 385/33; 359/641

(57) ABSTRACT

The present invention provides an improved optical collimator. The optical collimator includes: a glass plate including a first face and a second face opposite to the first face; and a lens/spacer element optically coupled to the second face of the first glass plate. The lens/spacer element includes: a basal surface coupled to the second face of the glass plate, a lens optically coupled to the second face of the glass plate and coupled to the basal surface, a top surface opposite to the basal surface, and a first and a second side walls each coupled to the basal surface and the top surface. The present invention facilitates physical alignment and proper spacing relative to optical fibers and optical components, provides a simple means for constructing linear and two-dimensional arrays of collimators, and leads to improved utilization of space, decreased fabrication cost, and increased system-level yield.

### FIELD OF THE INVENTION

The present invention relates generally to integrated optics utilized in fiber optic communications. More particularly, the present invention relates to an optical collimator utilized in fiber optic communications.

### BACKGROUND OF THE INVENTION

Because of an increasing demand for telecommunications information carrying capacity, wavelength division multiplexing (WDM) is becoming the method of choice for transmitting optical data over optical fiber communications systems. Wavelength division multiplexing is a method whereby multiple information-carrying signals or channels, each such channel comprising light of a specific restricted wavelength range, are transmitted along the same optical fiber. Wavelength division multiplexed optical communications systems may respond to the increasing demands for optical carrying capacity by an increase in channel counts. These increasing channel counts lead to an increased need for the optical components, known as wavelength division multiplexers, that perform the wavelength (channel) separation and recombination necessary for propagation of multiple optical channels along the same optical fiber. Although expanding optical fiber communications systems require increasing numbers of wavelength division multiplexers and other optical components, such as dispersion compensators, photonic processors, etc., the space available to accommodate such components, in optical switching centers, for instance, is generally limited. Therefore, optical components utilized in WDM systems must be small.

One important and necessary apparatus for optically coupling optical fibers to optical components is an optical collimator. An optical collimator receives diverging signal light from an optical fiber and transforms this signal light into substantially parallel rays for delivery to the optical components. Because light ray paths through the collimator are generally reversible, the same collimator receives output signal light from the optical components comprising substantially parallel rays and transforms this light into a converging light such that the signal light is focused onto an optical fiber end face and thereby delivered to the fiber.

FIG. 1 illustrates an example of a conventional optical fiber collimator. The collimator 100 (FIG. 1) comprises a micro-optic lens 104 disposed at a distance from fiber 102 equivalent to the focal length for the lens. The lens may be bi-convex as shown or else may be plano-convex or may comprise a composite structure consisting of multiple lenses in juxtaposition. An optical signal 101 may be output from the fiber 102, collimated (i.e., set as substantially parallel rays) by the lens 104 and then delivered to the optical apparatus or system 106. In the reverse sense of operation, a collimated signal 101 may be output from the optical apparatus or system 106 and then focused by the lens 104 into the fiber 102. The optical signal 101 comprises a converging or diverging cone of light between the fiber 102 and the lens 104 and comprises a collimated beam at the side of lens 104 opposite to the fiber 102. Although the collimator 100 is capable of performing its function exceptionally well, it presents some difficulties and inefficiencies in terms of optical alignment. For instance, the lens 104 must be accurately spaced at a distance f from the optical fiber 102, and the optical axis of the lens 104 must the axis 109. Frequently, the lens 104 must also be disposed at a certain controlled distance d from the optical apparatus or system 106. Difficulties in alignment and spacing arise from the fact that the lens 104 comprises convex curved surfaces on one or both sides and is generally small—from one to several millimeters—in diameter. Further, the distance f must normally be small—from one to several millimeters, all of which makes this design difficult to manufacture.

One successful conventional means for providing miniaturized optical components that overcome the above mentioned difficulties associated with curved surface micro-optic lenses has been through the use of graded index (GRIN) micro-lenses. FIG. 2 illustrates an example of a conventional fiber optic collimator that utilizes a GRIN lens. In the collimator system 200 illustrated in FIG. 2, the optical fiber 102 is positioned directly against the GRIN lens 204. The GRIN lens 204, whose construction and operation are well-known in the art, comprises a cylindrical glass rod with a radial refractive index gradient in which the index of refraction changes as one moves radially from the optical axis 207. Generally, the radial index n(r) of commercially available GRIN lenses resembles a parabolic function of radial distance from the optical axis 207 given by n(r)=nₒ(1−A r²/2), where nₒ is the refractive index along the center axis, A is the lens profile constant and r is the radial coordinate. Because of this refractive index profile, the signal light 101 follows a sinusoidal path within the GRIN lens 204. The proportion of a full sine wave traversed by light within the GRIN lens 204 depends upon the length p of the lens and is known as the pitch of the lens. To produce a collimated output signal light 101 at the side opposite from the fiber 102, the GRIN lens 204 must comprise 0.25 pitch.

The conventional GRIN-lens based collimator 200 solves some of the aforementioned alignment difficulties because the end surfaces 206a-206b of the GRIN lens 204 are nominally parallel to one another and at a known distance p from one another. Thus, the fiber 102 can be abutted against the GRIN lens 204 and the lens can either be abutted against or conveniently spaced from the optical apparatus or system 106. The cylindrical form of the GRIN lens also facilitates handling.

Despite the generally successful use of GRIN lenses in optical collimator systems, it has been found that GRIN lenses possess some properties that cause difficulties or inconveniences in incorporating them into collimators. Firstly, it has been empirically determined that the value of the parameter “A” in the above-noted formula for GRIN lens refractive index can vary substantially from one production lot to another and can even vary from one GRIN lens to another within a production lot. This variation causes a variation in the optical pitch between each GRIN lens lot. As a result, when GRIN lenses are incorporated into larger optical systems, provision must generally be made for physical adjustment of (i) the distance between the GRIN lens 204 and the mating optical apparatus or system 106, (ii) the distance between the GRIN lens 204 and the optical fiber 102, or (iii) the distance of the optical fiber 102 from the optical axis 207 in the radial direction. The incorporation of such adjustment mechanisms into optical systems leads to undesirable increased complexity and size of these optical systems, production inefficiency, and yield problems. Also, it has been found that the optical transmission through GRIN lenses tends to deteriorate upon exposure to ultraviolet (UV) light. Unfortunately, the fabrication of optical systems often requires one or more UV treatments in order to cure the epoxy that is used to bond the various optical components. The deleterious effects of these UV treatments upon GRIN lens transmission lead to undesirable optical insertion losses within the GRIN-lens-bearing optical systems and yield problems in the optical system. Further, the cylindrical shape of GRIN lenses does not facilitate simple fabrication of linear or two-dimensional arrays of optical collimators without the use of special holders, known as ferrules.

Accordingly, there exists a need for an improved optical collimator for use in optical communications systems. The improved collimator should avoid the use of independent curved-surface micro-lenses or GRIN lenses while still accomplishing collimation and focusing functions. The present invention addresses such a need.

### SUMMARY OF THE INVENTION

The present invention provides an improved optical collimator. The optical collimator includes: a glass plate including a first face and a second face opposite to the first face; and a lens/spacer element optically coupled to the second face of the first glass plate. The lens/spacer element includes: a basal surface coupled to the second face of the glass plate, a lens optically coupled to the second face of the glass plate and coupled to the basal surface, a top surface opposite to the basal surface, and a first and a second side walls each coupled to the basal surface and the top surface. The present invention facilitates physical alignment and proper spacing relative to optical fibers and optical components, provides a simple means for constructing linear and two-dimensional arrays of collimators, and leads to improved utilization of space, decreased fabrication cost, and increased system-level yield.

### BRIEF DESCRIPTION OF THE FIGURES

FIG. 1 illustrates a conventional fiber optic collimator that utilizes a curved lens.

FIG. 2 illustrates a second conventional fiber optic collimator that utilizes a graded-index (GRIN) lens.

FIG. 3a illustrates a first preferred embodiment of an optical collimator in accordance with the present invention.

FIG. 3b illustrates a second preferred embodiment of an optical collimator in accordance with the present invention.

FIGS. 4a-4b respectively illustrate a detailed cut-away view and top view of a lens/spacer element that is utilized within the first and second preferred embodiments of the optical collimator in accordance with the present invention.

FIGS. 4c-4f illustrate four alternative forms of the lens/spacer element that may be utilized in the first and second preferred embodiments of the optical collimator in accordance with the present invention.

FIG. 5a-5b illustrate two collimation systems which utilize the optical collimator in accordance with the present invention.

FIG. 6a illustrates a third preferred embodiment of the optical collimator in accordance with the present invention.

FIG. 6b illustrates a fourth preferred embodiment of the optical collimator in accordance with the present invention.

FIGS. 7a-7c illustrate cut-away views of three alternative lens/spacer arrays as utilized within the fourth preferred embodiment of the optical collimator in accordance with the present invention.

FIG. 8a illustrates a fifth preferred embodiment of the optical collimator in accordance with the present invention.

FIGS. 8b and 8c illustrate a first method for fabricating a plurality of optical collimators in accordance with the present invention.

FIG. 8d illustrate a second method for fabricating a plurality of optical collimators in accordance with the present invention.

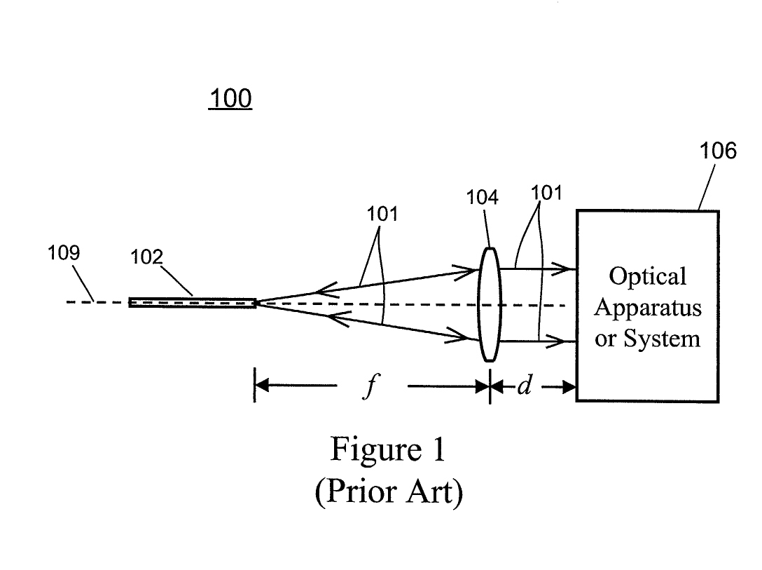

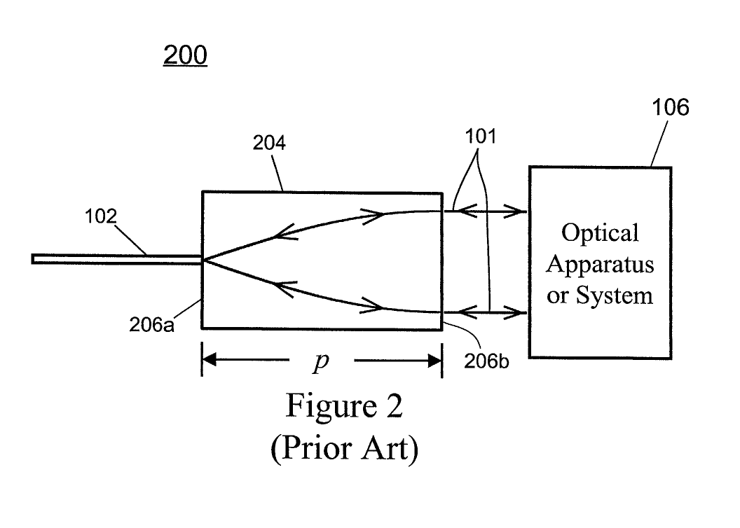

### DETAILED DESCRIPTION

The present invention provides an improved optical collimator. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

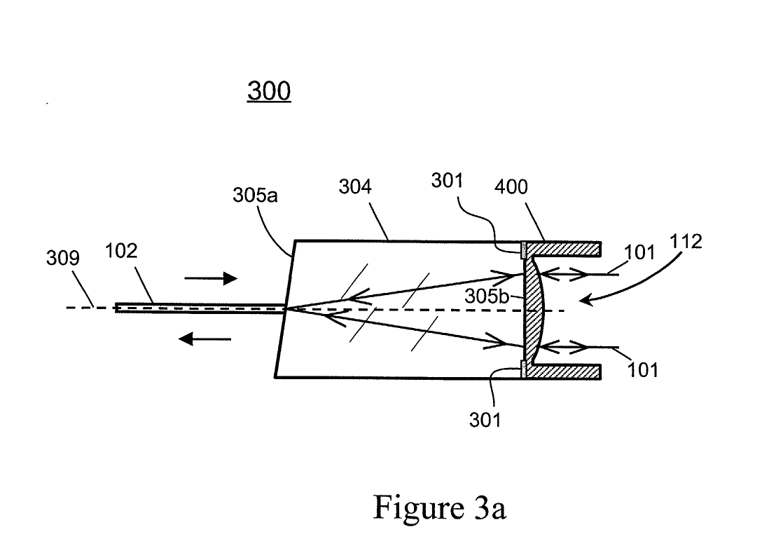

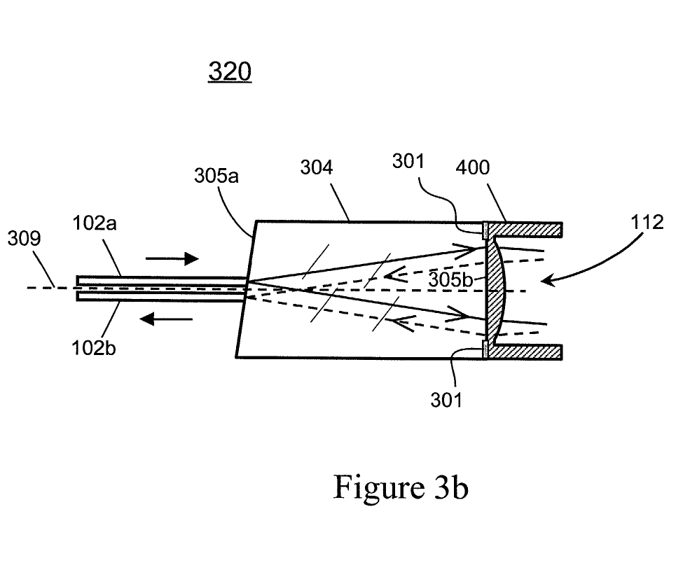

To more particularly describe the features of the present invention, please refer to FIGS. 3a through 8c in conjunction with the discussion below.

FIG. 3a illustrates a first preferred embodiment of an optical collimator in accordance with the present invention. The optical collimator 300 comprises an optical fiber 102, a glass plate 304 that is optically coupled to the optical fiber 102 and a lens/spacer element 400 optically coupled to the glass plate 304 at a side opposite to the optical fiber 102. The glass plate 304 comprises a first end face 305a and a second end face 305b. The end face 305a is disposed at a slight angle to the axis 309 of the fiber 102 to prevent unwanted back reflections. The lens/spacer element 400 is affixed to face 305b by adhesive 301 which is preferably epoxy. A signal light 101 is output from fiber 102, diverges within plate 304, is collimated by lens/spacer element 400 and then propagates through the free space region 112 as a collimated beam, centered upon axis 309.

FIG. 3b illustrates a second preferred embodiment of the optical collimator in accordance with the present invention. The optical collimator 320 is the same as the optical collimator 300 (FIG. 3a) except the optical collimator 320 comprises two optical fibers 102a-102b. The two fibers 102a-102b are disposed at equal offset distances at opposite sides of the axis 309 that is parallel to each of these fibers 102a-102b and passes through the center of the convex lens surface 305b. Because of this disposition of the fibers 102a-102b, collimated light passing through the space 112 does not pass parallel to the axis 309, but rather passes therethrough at an angle as illustrated in FIG. 3b.

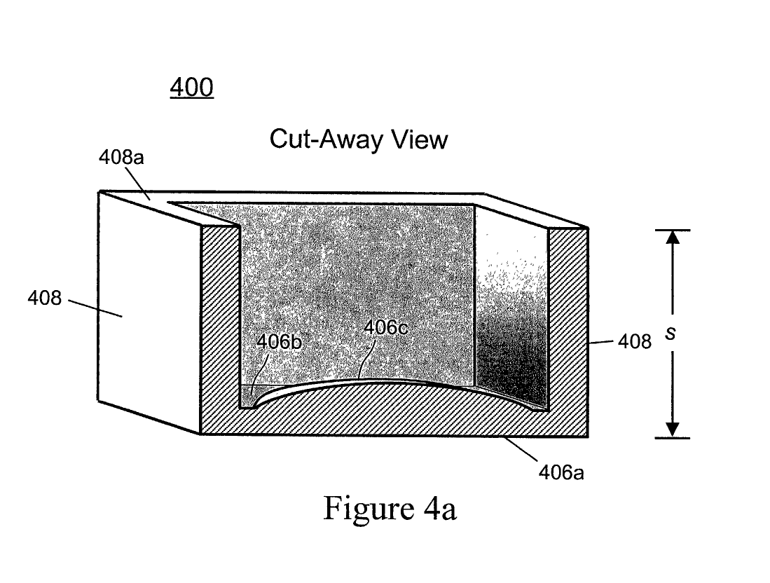

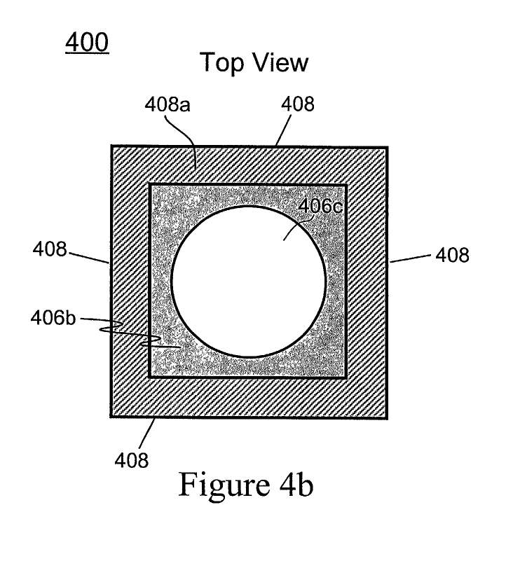

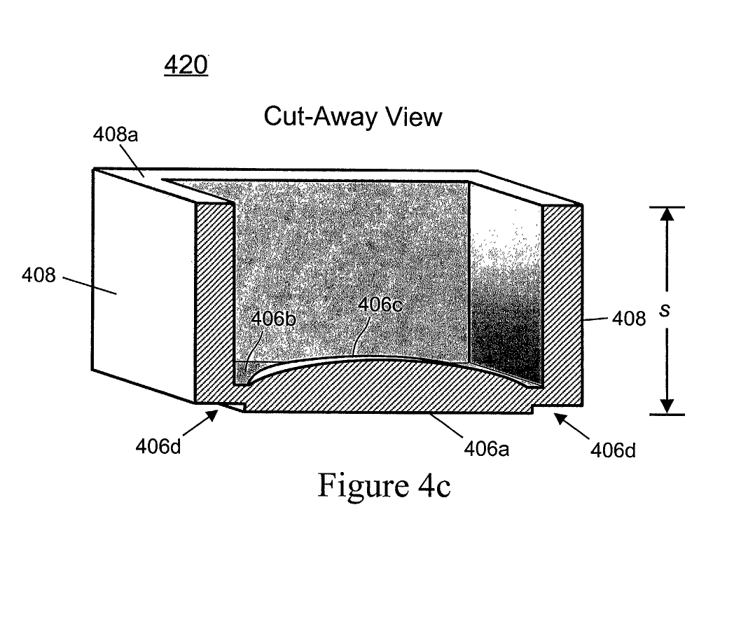

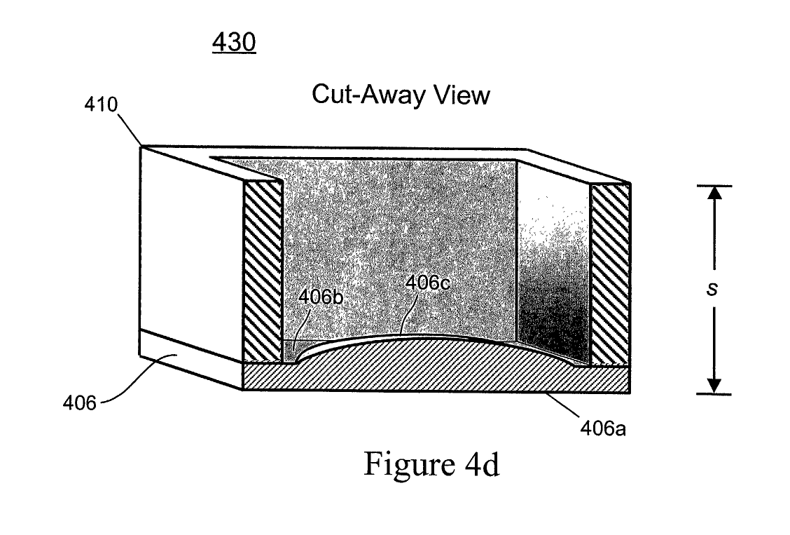

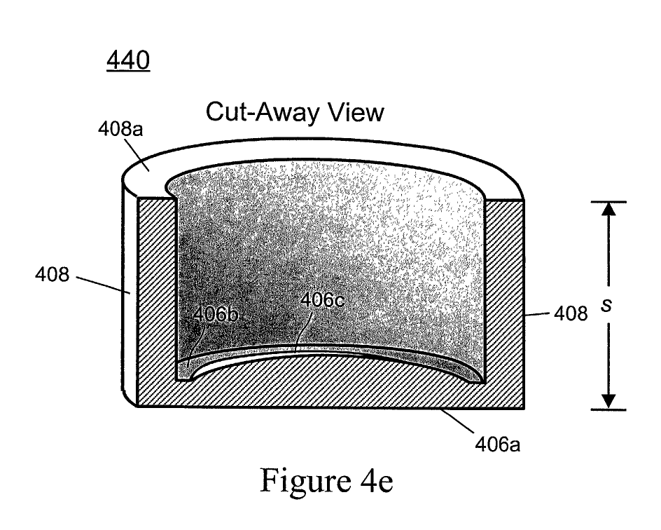

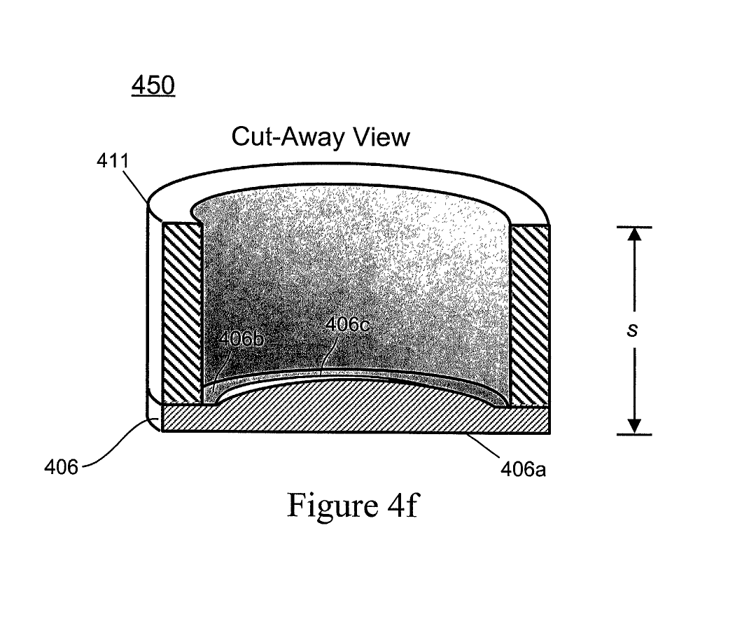

FIGS. 4a-4b respectively illustrate a detailed cut-away view and top view of a lens/spacer element as utilized within the first and second preferred embodiments of the optical collimator in accordance with the present invention. The lens/spacer element 400 comprises a single piece of material of a complex shape and may be approximately described as a rectangular block hollowed out from one side with a lens surface on the interior face of the opposing side. The material comprising the lens/spacer element 400 comprises an optically isotropic material, preferably glass or solid polymer, which can be cut from or molded into a single piece.

Specifically, the lens/spacer element 400 (FIGS. 4a-4b) comprises a floor section integrated with four side-wall sections 408. The floor section comprises a substantially flat exterior basal surface 406a, a flat interior floor surface 406b adjoining the side-walls 408 and a raised convex lens surface 406c protruding centrally above the interior floor surface. The exterior basal surface 406a defines a “bottom” of the lens/spacer element 400. The top surface 408a is substantially flat and substantially parallel to the basal surface 406a and comprises all of the ends of the four side-wall segments 408.

In operation, the raised convex surface 406c performs the function of either a collimating or focusing lens for a through-going set of light rays, wherein the light rays are constrained to pass only through the portion of the floor section lying “underneath” the convex surface 406c. The top surface 408a and the portion of the exterior basal surface 406a lying “underneath” the flat interior floor surface 406b and the side walls 408 comprise attachment areas of the lens/spacer element 400 whereupon adhesive 301 may be applied (FIGS. 3a-3b). Through this attachment configuration, light is prevented from passing through the adhesive. The four side-wall segments 408 comprise spacers of length s. The magnitude of s is chosen so that bottom-to-top propagating signal light, after having been collimated and/or diverted by the convex lens surface 406c, impinges upon the correct portion of an optical apparatus or system that may be attached or physically coupled to the top surface 408a.

FIGS. 4c-4f illustrate four alternative forms of the lens/spacer element that may be utilized in the first preferred embodiment of the optical collimator in accordance with the present invention. The lens/spacer element 420 (FIG. 4c) comprises a set of grooves 406d that are cut into the edges of the exterior portion of the floor section. The grooves 406d can accommodate epoxy or other adhesive to permit the lens/spacer element 420 to be bonded to the glass plate 304 without introducing separation between the lens/spacer element and the glass plate. The lens/spacer element 430 illustrated in FIG. 4d comprises a side-wall piece 410 and floor piece 406, wherein these two pieces are fabricated separately and subsequently bonded to one another or fused together. The floor piece 406 comprises the flat exterior basal surface 406a, the flat interior floor surface 406b and the raised convex lens surface 406c previously described. FIG. 4e illustrates a single piece lens/spacer element 440 within which the side-wall section 408 is curved, and preferably circular in cross section. FIG. 4f illustrates a two piece lens/spacer element 450 comprising a curved side-wall piece 411 fused or bonded to a floor piece 406.

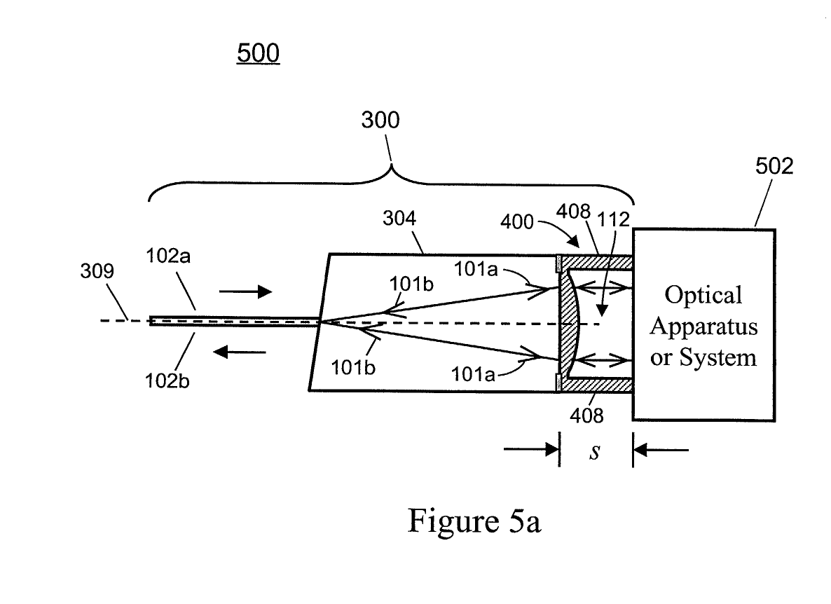

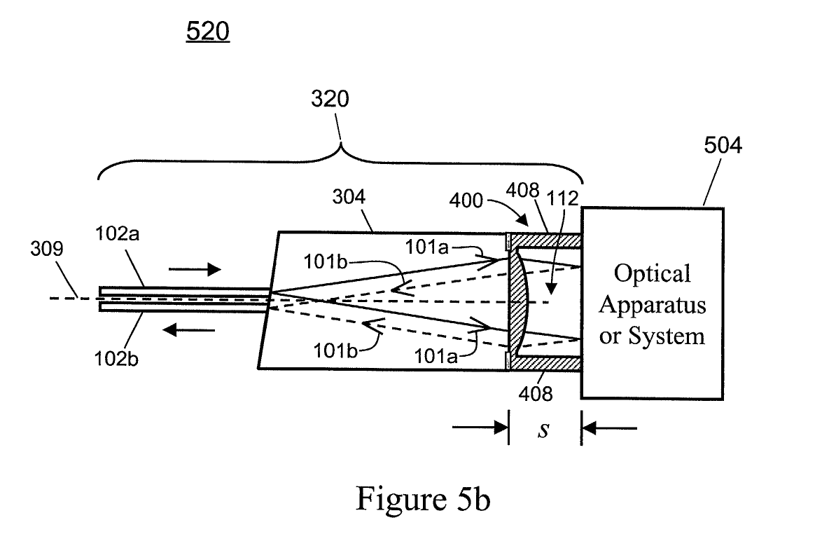

FIGS. 5a-5b illustrate two collimation systems which utilize the optical collimator in accordance with the present invention. In the first such collimation system 500 illustrated in FIG. 5a, an optical signal or signals are either received from or delivered to a single optical fiber 102. Any optical signal(s) 101a received from the fiber 102 are delivered to the optical apparatus or system 502 that is physically coupled to the top surface 408a (FIG. 4a) of the lens/spacer element 400 of the optical collimator 300. The optical signal(s) 101a are input to the optical apparatus or system 502 as a collimated beam that is substantially parallel to and centered upon an axis 309 defined by the optical fiber 102 and the center of the convex lens portion 406c (FIG. 4a). Simultaneously or alternatively, another optical signal or signals 101b may be delivered from the optical apparatus or system 502 to the optical fiber 102 along a path that is substantially reversed from that of signal(s) 101a.

FIG. 5b illustrates a second collimation system that utilizes the optical collimator in accordance with the present invention. In the collimation system 520, the two fibers 102a-102b are disposed at equal offset distances at opposite sides of an axis 309 that is parallel to each of these fibers and passes through the center of the convex lens surface 406c. Because of this disposition of the fibers, collimated light passing though the space 112 does 20 not pass parallel to the axis 309, but rather passes therethrough at an angle as illustrated in FIG. 5b. The system illustrated in FIG. 5b is convenient for utilization with optical devices, such as those containing thin film filters, which require light to pass through certain components at an angle that is not 90° and those which reflect all or a portion of the light. The optical apparatus or system 504 need not be in intimate contact with the lens/spacer element 400 but may also be spaced away along the axis 309.

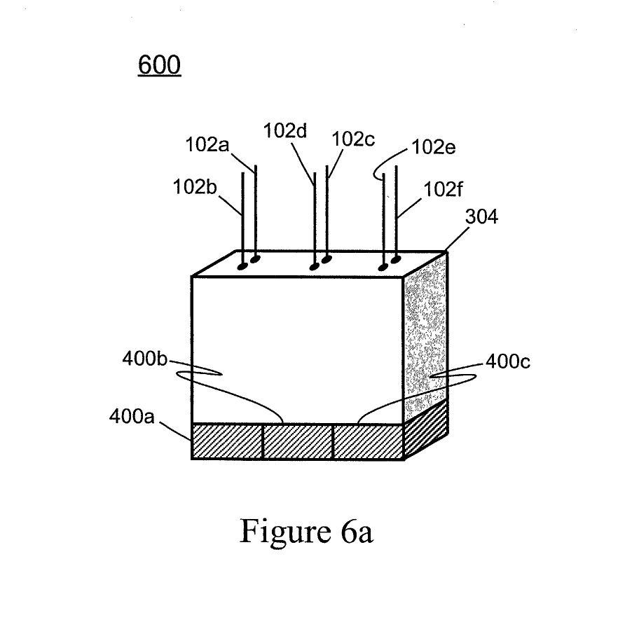

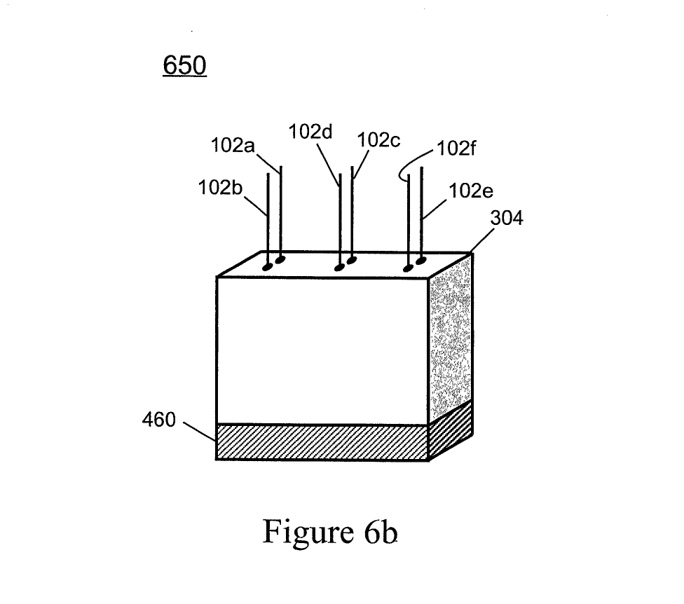

FIG. 6a illustrates a third preferred embodiment of the optical collimator in accordance with the present invention. The optical collimator 600 is an integrated linear collimator array 600 (FIG. 6a). It performs the same collimator functions as would a set of adjacent parallel collimators, such as collimators 320 (FIG. 3b). In other words, a first, second, and third set of collimation operations may be performed with respect to optical signals travelling along the set of fibers 102a-102b, the set of fibers 102c-102d and the set of fibers 102e-102f, respectively, wherein each of the first through third sets of collimation operations occurs independently from and simultaneously with the others. However, in the integrated linear collimator array 600 (FIG. 6a), a single glass plate 304 replaces the multiple adjacent glass plates that would be required within a set of three adjacent parallel collimators. Physically coupled to the single glass plate 304 is a set of lens/spacer elements 400a-400c. It will be readily recognized that the linear collimator array 600 may be constructed with each adjacent pair of fibers (such as fibers 102a-102b) replaced by a single fiber so as to replicate the same collimator functions as would be provided by a set of adjacent parallel collimators 300 (FIG. 3a).

FIG. 6b illustrates a fourth preferred embodiment of the optical collimator in accordance with the present invention. The fourth preferred embodiment is also an integrated linear collimator array 650, but it provides further consolidation of component parts relative to the integrated linear collimator array 600 (FIG. 6a). The collimator array 650 performs the same collimator functions device as would a set of adjacent parallel collimators 320 (FIG. 3b) or as does the collimator array 600 (FIG. 6a). However, in the collimator array 650 (FIG. 6b), the set of lens/spacer elements 400a-400c are replaced by the single lens/spacer array 460, wherein the lens/spacer array 460 is physically and optically coupled to the glass plate 304.

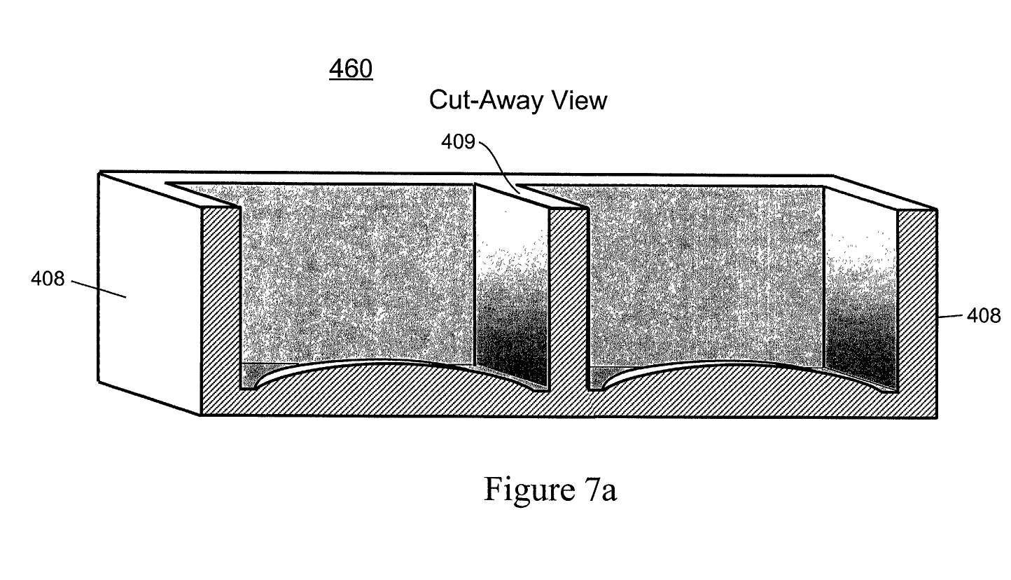

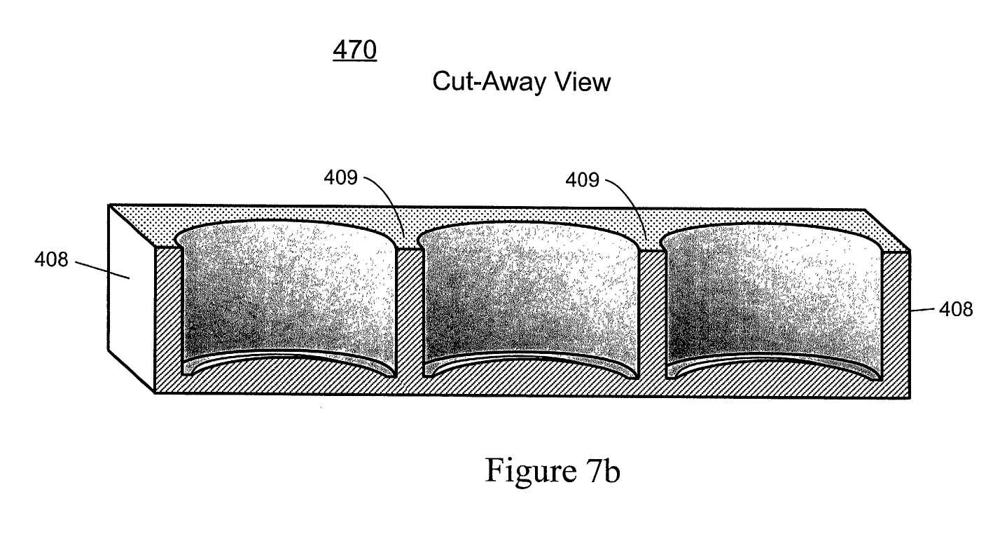

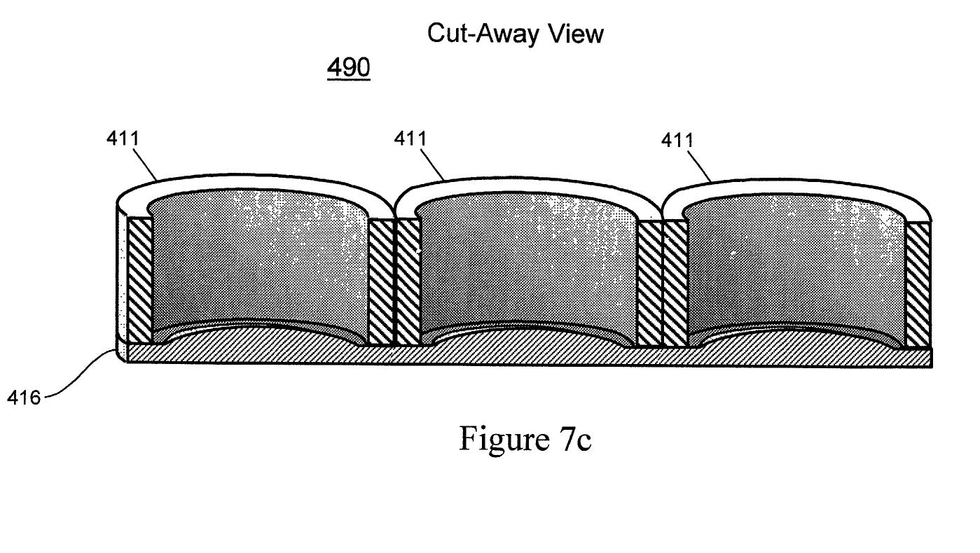

FIG. 7a illustrates a cut-away view of the lens/spacer array 460 as utilized in the integrated linear collimator array 650 in accordance with the present invention. The lens/spacer array 460 is constructed similarly to a set of lens/spacer elements 400 disposed side-by-side except that the adjacent hollow regions are separated by internal partitions 409 instead of by side wall elements 408. The lens/spacer array 460 is cut or molded from a single piece of material, so that fabrication and assembly costs are minimized. FIG. 7b illustrates a cut-away view of a first alternative lens/spacer array 470 that may be utilized within the integrated linear collimator array 650 (FIG. 6b) in accordance with the present invention. The lens/spacer array 470 may be used in place of the lens/spacer array 460. FIG. 7c illustrates a cut-away view of a second alternative lens/spacer array 490 that may be utilized within the integrated linear collimator array 650 in accordance with the present invention. The lens/spacer array 490 comprises a single floor piece 416 which comprises a lens array. A plurality of side walls 411 is then bonded or fused with the floor piece 416.

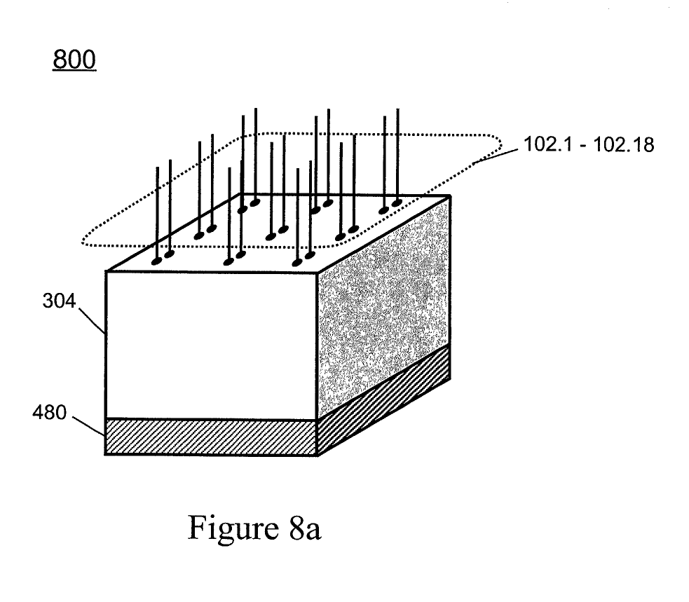

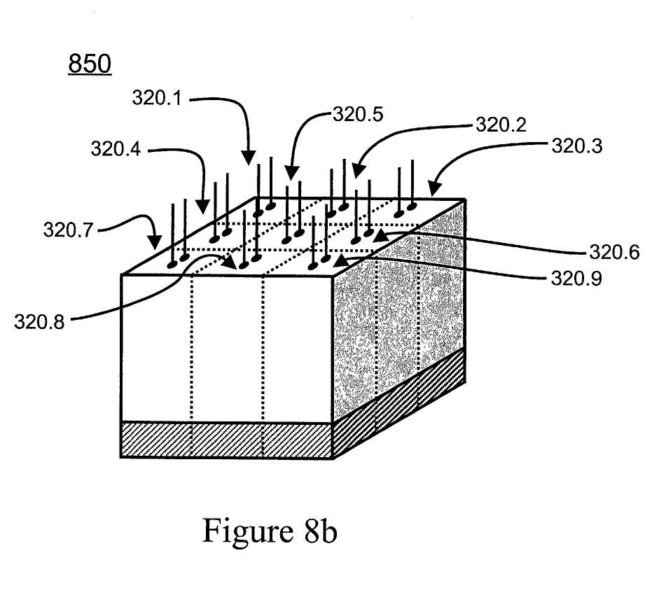

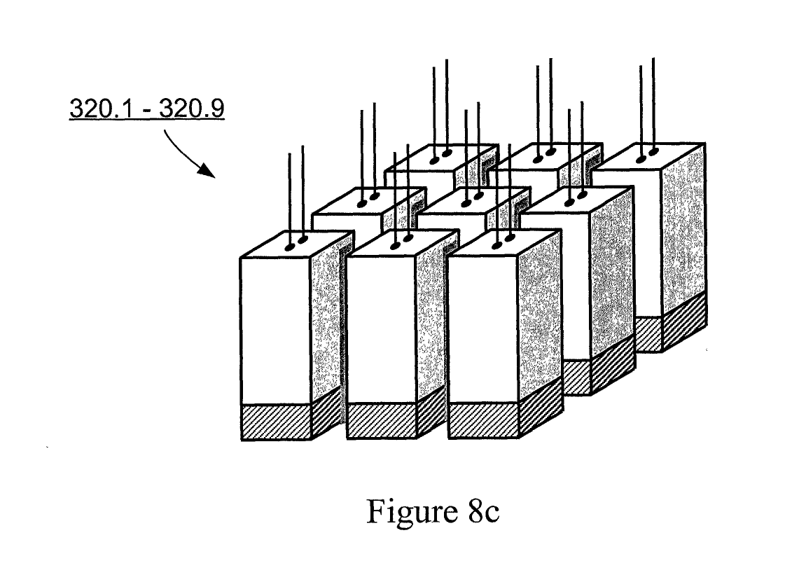

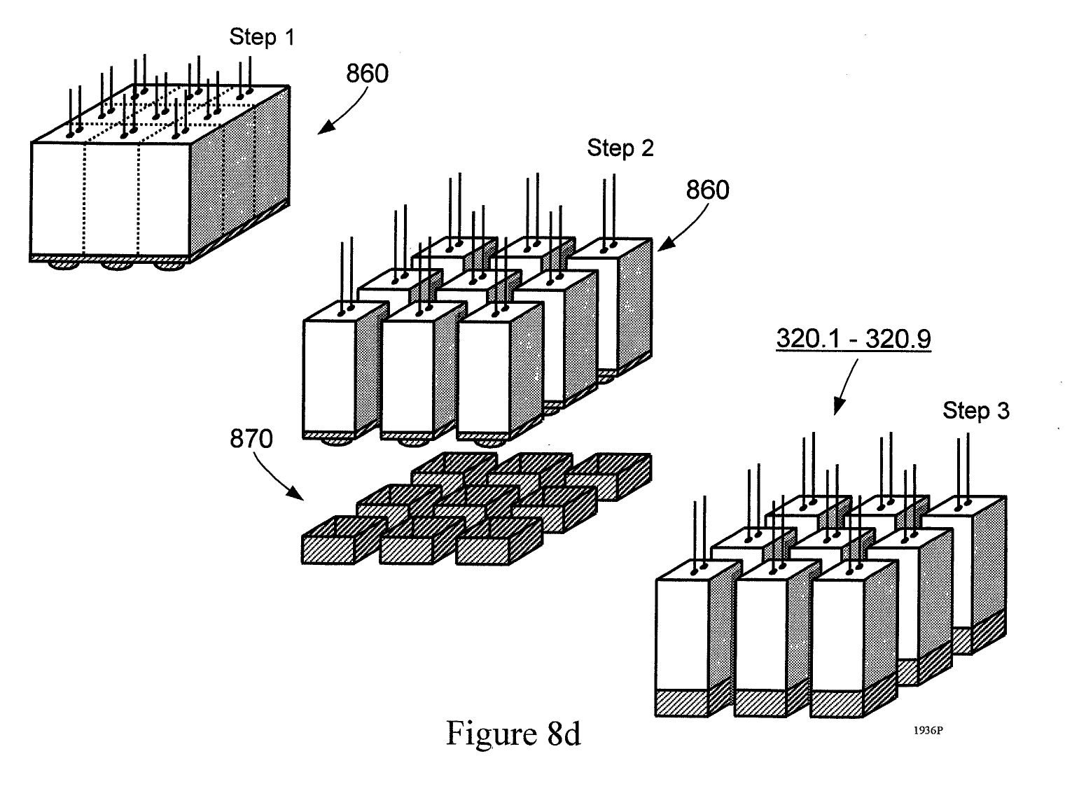

FIG. 8a illustrates a fifth preferred embodiment of the optical collimator in accordance with the present invention. The collimator 800 (FIG. 8a) comprises an integrated two-dimensional collimator array that is similar to the integrated linear array collimator array 650 (FIG. 6b) except for the extension to two dimensions. Functionally, the collimator 800 operates as a two-dimensional array of n adjoined but independent collimator apparatuses 320.1, 320.2, . . . , 320.n as schematically illustrated in FIG. 8b, wherein each one of the adjoined “apparatuses” comprises a pair of fibers optically coupled to the plate 304 (FIG. 8a). FIG. 8a illustrates a 3×3 array comprising nine of such “apparatuses” (that is, n=9). Therefore, as illustrated in FIG. 8a, nine pairs of fibers—comprising the eighteen fibers 102.1-102.18—are optically coupled to the plate 304. However, the integrated two-dimensional array collimator 800 need not be limited to any particular array size.

FIGS. 8b and 8c illustrate a first method for fabricating a plurality of optical collimators in accordance with the present invention. First, an integrated two-dimensional array collimator, such as the collimator 800 is fabricated, according to the structure shown in FIG. 8a. The integrated two-dimensional array collimator 800 is then cut or otherwise separated, as illustrated in FIG. 8b, along planes so as to separate individual collimators from the two-dimensional array. These planes are indicated by dotted lines in FIG. 8b. After separation or cutting, a plurality of separated collimators then exist, as shown by the nine separate individual collimators 320.1-320.9 in FIG. 8c. The fabrication method illustrated in FIGS. 8b and 8c is much more efficient than that used for conventional optical collimators utilizing conventional or GRIN lenses, since the assembly of components is only performed once in the fabrication of multiple devices.

FIG. 8d illustrates a second method of fabricating a plurality of optical collimators in accordance with the present invention. First, a two-dimensional array 860 of collimators, without the side walls, is fabricated (step 1). Next, the array of collimators 860 is cut or otherwise separated along planes so as to separate individual collimators from the two-dimensional array 680 (step 2). Then, a plurality of side walls 870, are individually fused or bonded to the separated individual collimators (step 3). After separation, a plurality of separated collimators 320.1-320.9 exist.

An improved optical collimator has been disclosed. The optical collimator in accordance with the present invention comprises a set of optical fibers, a glass plate optically coupled to the set of optical fibers, and a lens/spacer optically coupled to the glass plate. The set of optical fibers comprises either a single fiber utilized for both input and output or else a pair of fibers comprising one input fiber and a separate output fiber. The lens/spacer element comprises a single integrated piece with a floor portion and four sidewall spacer portions wherein the central interior of the floor portion of each lens/spacer element is convex shaped so as to collimate optical signal light input to the collimator from an input fiber. Other embodiments of the present invention comprise integrated linear and two-dimensional array collimators wherein more than one set of fibers is optically coupled to the glass plate. The optical collimator in accordance with the present invention facilitates physical alignment and proper spacing relative to optical fibers and optical components and provides a simple means for constructing linear and two-dimensional arrays of collimators, improved utilization of space, decreased fabrication cost, and increased system level yield.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. An optical collimator, comprising:
a glass plate comprising a first face and a second face opposite to the first face; and
a lens/spacer element optically coupled to the second face of the first glass plate, wherein the lens/spacer element comprises:
a basal surface coupled to the second face of the glass plate,
a lens optically coupled to the second face of the glass plate and coupled to the basal surface,
a top surface opposite to the basal surface, and
a first and a second side walls each coupled to the basal surface and the top surface.

2. The collimator of claim 1, wherein the basal surface comprises:
an exterior basal surface; and
an interior floor surface.

3. The collimator of claim 1, wherein the top surface is substantially parallel to the basal surface.

4. The collimator of claim 1, wherein the lens/spacer element further comprises:
a plurality of grooves in the basal surface, wherein an adhesive may be placed within the plurality of grooves to couple the lens/spacer element to the second face of the glass plate.

5. The collimator of claim 1, wherein the first and second side walls are curved.

6. The collimator of claim 1, wherein the basal surface is bonded with the first and second side walls.

7. The collimator of claim 1, wherein the basal surface is fused with the first and second side walls.

8. The collimator of claim 1, further comprising:
a first optical fiber optically coupled to the first face of the glass plate.

9. The collimator of claim 8, further comprising:
a second optical fiber optically coupled to the first face of the glass plate.

10. An optical collimator, comprising:
a glass plate comprising a first face and a second face opposite to the first face; and
a plurality of lens/spacer elements, each optically coupled to the second face of the glass plate, wherein each of the plurality of the lens/spacer elements comprises:
a basal surface coupled to the second face of the glass plate,
a lens optically coupled to the second face of the glass plate and coupled to the basal surface,
a top surface opposite to the basal surface, and
a first and a second side walls each coupled to the basal surface and the top surface.

11. The collimator of claim 10, wherein the basal surface comprises:
an exterior basal surface; and
an interior floor surface.

12. The collimator of claim 10, wherein the top surface is substantially parallel to the basal surface.

13. The collimator of claim 10, wherein the lens/spacer element further comprises:
a plurality of grooves in the basal surface, wherein an adhesive may be placed within the plurality of grooves to couple the lens/spacer element to the second face of the glass plate.

14. The collimator of claim 10, wherein the first and second side walls are curved.

15. The collimator of claim 10, wherein the basal surface is bonded with the first and second side walls.

16. The collimator of claim 10, wherein the basal surface is fused with the first and second side walls.

17. The collimator of claim 10, wherein each of the plurality of lens/spacer elements further comprises:
a first optical fiber optically coupled to the first face of the glass plate.

18. The collimator of claim 17, wherein each of the plurality of lens/spacer elements further comprises:
a second optical fiber optically coupled to the first face of the glass plate.

19. An optical collimator, comprising:
a glass plate comprising a first face and a second face opposite to the first face; and
an array of lens/spacer elements, each optically coupled to the second face of the glass plate, wherein the array of lens/spacer elements comprises:
a basal surface coupled to the second face of the glass plate,
a lens array optically coupled to the second face of the glass plate and coupled to the basal surface,
a top surface opposite to the basal surface, and
a plurality of side walls coupled to the basal surface and the top surface.

20. The collimator of claim 19, wherein the basal surface comprises:
an exterior basal surface; and
an interior floor surface.

21. The collimator of claim 19, wherein the top surface is substantially parallel to the basal surface.

22. The collimator of claim 19, wherein the lens/spacer element further comprises:
a plurality of grooves in the basal surface, wherein an adhesive may be placed within the plurality of grooves to couple the array of lens/spacer elements to the second face of the glass plate.

23. The collimator of claim 19, wherein the plurality of side walls are curved.

24. The collimator of claim 19, wherein the basal surface is bonded with the plurality of side walls.

25. The collimator of claim 19, wherein the basal surface is fused with the plurality of side walls.

26. The collimator of claim 19, wherein each lens/spacer element in the array of lens/spacer elements further comprises:
a first optical fiber optically coupled to the first face of the glass plate.

27. The collimator of claim 26, wherein each lens/spacer element in the array of lens/spacer elements further comprises:
a second optical fiber optically coupled to the first face of the glass plate.

28. The collimator of claim 19, wherein the array is a one-dimensional array.

29. The collimator of claim 19, wherein the array is a two-dimensional array.

30. A method for fabricating an optical collimator, comprising the steps of:
(a) providing an array of optical devices, wherein each optical device in the array comprises:
a glass plate comprising a first face and a second face opposite to the first face, and
a lens/spacer element optically coupled to the second face of the glass plate, wherein the lens/spacer element comprises:
a basal surface coupled to the second face of the glass plate,
a lens optically coupled to the second face of the glass plate and coupled to the basal surface,
a top surface opposite to the basal surface, and
a first and a second side walls each coupled to the basal surface and the top surface; and
(b) cutting the array wherein the optical devices in the array are separated from each other.

31. A method for fabricating an optical collimator, comprising the steps of:
(a) providing an array of optical devices, wherein each optical device in the array comprises:
a glass plate comprising a first face and a second face opposite to the first face, and
a lens/spacer element optically coupled to the second face of the glass plate, wherein the lens/spacer element comprises:
a basal surface coupled to the second face of the glass plate,
a lens optically coupled to the second face of the glass plate and coupled to the basal surface, and
a top surface opposite to the basal surface;
(b) cutting the array wherein the optical devices in the array are separated form each other; and
(c) coupling a plurality of side walls to the separated plurality of optical devices.

32. A system, comprising:
an optical collimator, comprising:
a glass plate comprising a first face and a second face opposite to the first face, and
a lens/spacer element optically coupled to the second face of the glass plate, wherein the lens/spacer element comprises:
a basal surface coupled to the second face of the glass plate,
a lens optically coupled to the second face of the glass plate and coupled to the basal surface,
a top surface opposite to the basal surface, and
a first and a second side walls each coupled to the basal surface and the top surface; and
an optical device optically coupled to the lens/spacer element at a side opposite to the glass plate.

33. The system of claim 32, wherein the basal surface comprises:
an exterior basal surface; and
an interior floor surface.

34. The system of claim 32, wherein the top surface is substantially parallel to the basal surface.

35. The system of claim 32, wherein the lens/spacer element further comprises:
a plurality of grooves in the basal surface, wherein an adhesive may be placed within the plurality of grooves to couple the lens/spacer element to the second face of the glass plate.

36. The system of claim 32, wherein the first and second side walls are curved.

37. The system of claim 32, wherein the basal surface is bonded with the first and second side walls.

38. The system of claim 32, wherein the basal surface is fused with the first and second side walls.

39. The system of claim 32, further comprising:
a first optical fiber optically coupled to the first end face of the glass plate.

40. The system of claim 39, further comprising:
a second optical fiber optically coupled to the first end face of the glass plate.

41. The system of claim 32, wherein the optical device is coupled to the lens/spacer element.

42. The system of claim 32, wherein the optical device is not coupled to the lens/spacer element.

43. A system, comprising:
a plurality of optical collimators, each optical collimator comprising:
a glass plate comprising a first face and a second face opposite to the first face, and
a lens/spacer element optically coupled to the second face of the glass plate, wherein the lens/spacer element comprises:
a basal surface coupled to the second face of the glass plate,
a lens optically coupled to the second face of the glass plate and coupled to the basal surface,
a top surface opposite to the basal surface, and
a first and a second side walls each coupled to the basal surface and the top surface; and
a plurality of optical devices, each optical device optically coupled to the lens/spacer element of each of the plurality of optical collimators at a side opposite to the glass plate.

44. The system of claim 43, wherein the basal surface comprises:
an exterior basal surface; and
an interior floor surface.

45. The system of claim 43, wherein the top surface is substantially parallel to the basal surface.

46. The system of claim 43, wherein the lens/spacer element further comprises:
a plurality of grooves in the basal surface, wherein an adhesive may be placed within the plurality of grooves to couple the lens/spacer element to the second face of the glass plate.

47. The system of claim 43, wherein the first and second side walls are curved.

48. The system of claim 43, wherein the basal surface is bonded with the first and second side walls.

49. The system of claim 43, wherein the basal surface is fused with the first and second side walls.

50. The system of claim 43, further comprising:
a first optical fiber optically coupled to the first end face of the glass plate.

51. The system of claim 50, further comprising:
a second optical fiber optically coupled to the first end face of the glass plate.

52. The system of claim 43, wherein the optical device is coupled to the lens/spacer element.

53. The system of claim 43, wherein the optical device is not coupled to the lens/spacer element.
